(19) United States
(12) Patent Application Publication
(10) Pub. No.: US 2017/0193677 A1
(43) Pub. Date: Jul. 6, 2017

(54) APPARATUS AND METHOD FOR RECONSTRUCTING EXPERIENCE ITEMS

(71) Applicant: ELECTRONICS AND TELECOMMUNICATIONS RESEARCH INSTITUTE, Daejeon (KR)

(72) Inventors: Tae-Joon KIM, Daejeon (KR); Ho-Won KIM, Seoul (KR); Sung-Ryull SOHN, Daejeon (KR); Ki-Nam KIM, Seoul (KR); Hye-Sun PARK, Daejeon (KR); Kyu-Sung CHO, Daejeon (KR); Chang-Joon PARK, Daejeon (KR); Jin-Sung CHOI, Daejeon (KR)

(21) Appl. No.: 15/226,317

(22) Filed: Aug. 2, 2016

(30) Foreign Application Priority Data
Jan. 4, 2016 (KR) 10-2016-0000702

(51) Int. Cl. G06T 11/00; G06T 15/08; G06T 19/20; G06T 17/20

(52) U.S. Cl. CPC G06T 11/003; G06T 17/205; G06T 15/08; G06T 19/20

(57) ABSTRACT

An apparatus and method for reconstructing an experience item in 3D. The apparatus for reconstructing an experience item in 3D includes a 3D data generation unit for generating 3D data by reconstructing the 3D shape of a target object to be reconstructed in 3D, a 2D data generation unit for generating 2D data by performing 2D parameterization on the 3D data, an attribute setting unit for assigning attribute information corresponding to the target object to the 3D data, an editing unit for receiving editing of the 2D data from a user, and an experience item generation unit for generating an experience item corresponding to the target object using the 3D data corresponding to the edited 2D data and the attribute information.

### CROSS REFERENCE TO RELATED APPLICATION

This application claims the benefit of Korean Patent Application No. 10-2016-0000702, filed Jan. 4, 2016, which is hereby incorporated by reference in its entirety into this application.

### BACKGROUND OF THE INVENTION

1. Technical Field

The present invention relates generally to the 3D reconstruction of an experience item. More particularly, the present invention relates to technology for reconstructing the 3D shape of a target object and creating an experience item corresponding to the target object by receiving editing and attributes through a 2D authoring environment.

2. Description of the Related Art

With the recent development and popularization of sensors capable of measuring depth, objects having various shapes are being reconstructed and digitized. These sensors are widely used in various application fields such as visualization, simulations, and the like. In particular, the introduction of Microsoft's Kinect sensor enables the acquisition of depth information at low cost, and object reconstruction is expected to become more widely used. Further, Microsoft's KinectFusion provides a method by which a space having the volume of a room can be reconstructed in 3D. However, this method is inconvenient in that scanning a space and removing unnecessary parts from the reconstructed model must be performed manually.

Meanwhile, the emergence of technology, such as virtualization of clothing, online fitting, and the like, is expanding the field of experience services by which a user may easily check how the user would look wearing the clothing without trying on the clothing in the real world. However, the main problem with this service is that it is difficult to continuously supply virtual items such as clothing.

Here, a virtual item may be produced using computer graphics authoring tools such as Autodesk Maya, or the 3D model thereof may be formed using patterns for real clothing. Alternatively, the 3D model of a virtual item may be reconstructed from images captured in various directions.

Here, the production method using authoring tools or the method using patterns for real clothing requires time-consuming work by skillful designers and is problematic in that it takes a lot of expense to produce items, and that it is very difficult to automate the production process.

Alternatively, the method using captured images is advantageous in that the natural appearance of an item may be quickly extracted at low cost, but because a stand on which the item is arranged, such as a mannequin, may also be extracted along with the item, post processing for removing the stand is necessary. Here, the stand may be removed manually using a 3D authoring tool, or may be removed through a chroma-key method, which is mainly used for compositing videos, an automated method using the 3D geometry of a mannequin, and the like. However, if a user is not an expert designer accustomed to a 3D authoring environment, it may take a lot of time to edit items.

In order to solve the above problems, a conventional 2D parameterization technique may be used. That is, a user may edit 3D data in a 2D editing environment through 2D parameterization, whereby convenience may be improved.

FIG. 1 is a view illustrating a method for representing 3D data in a 2D plane using conventional mesh parameterization.

Here, 2D parameterization is technology for representing 3D data in a 2D plane, as shown in FIG. 1. However, because conventional technology has been developed with the aim of reducing wasted space and minimizing distortion, it differs from the intention of editing 3D data in a 2D authoring environment.

As shown in FIG. 1, recently, 2D parameterization is used to minimize extension of the area of each element when flattened over a 2D plane. Here, distortion may be reduced by applying various methods, such as a method for minimizing the difference between the area of each element in 3D space and the area of the element in a 2D plane, a method for maintaining the angle between the vertices of each element, and the like. However, this conventional method has a problem in that it is difficult for a user to intuitively edit a desired part using 2D data because the data represented in a 2D plane may differ from the shape visually recognized by the user.

Meanwhile, in a chroma-key method, objects or areas other than the object of interest are covered with a preselected color and are then excluded from image processing by recognizing the preselected color. If the chroma-key method is used to remove a mannequin from a reconstructed model, the mannequin must be produced so as to have a specific color, and no color similar to the color of the mannequin can be used in the item to be reconstructed. Also, the color of the mannequin may affect the color of the item.

In the case of a method using the 3D geometry of a mannequin, if the precision of geometry is lower than a certain level, when an automated process is performed, an item may be removed along with a mannequin, or some parts of the mannequin may not be removed, thus requiring the use of another method to remove the remaining parts. Also, if the mannequin is an articulated mannequin, because its posture may be changed while items are arranged thereon, the 3D geometry thereof may become useless.

Meanwhile, in order to implement the realistic virtual fitting of reconstructed items, the conventional art uses a skinning method, which may enable items to move depending on the motion of a user, and a method to which physical simulation is applied in order to increase the level of realism. Here, skinning is a process in which each vertex of an item is associated with one or more bones and is made to move based on the movement of the associated bones, whereby the item is animated. Also, physical simulation is a method for emulating the movement or form of an item in the real world by moving or deforming an item according to the laws of motion.

In order to implement virtual fitting based on skinning or simulation, it is necessary to assign various attributes (i.e., weighting for a bone, a physical simulation property, and the like) to respective parts of a 3D data item. However, because the conventional art mainly uses a method in which attributes are assigned to each vertex using a painting method in a 3D authoring tool, it is inconvenient and time-consuming.

Therefore, there is urgently required technology for creating an experience item by enabling a user who is unaccustomed to a 3D authoring environment to easily edit a 3D item.

In connection with this, Korean Patent No. 10-1376880, discloses on Mar. 15, 2007 a technology related to “2D editing metaphor for 3D graphics.”

### SUMMARY OF THE INVENTION

An object of the present invention is to enable fast reconstruction of a 3D shape at low cost through an automated technique by which a 3D item may be reconstructed using image information.

Another object of the present invention is to enable a user, unaccustomed to a 3D authoring environment, to easily edit 3D data in a 2D authoring environment.

A further object of the present invention is to enable the fast supply of experience items by enabling the quick and simple creation of digital experience items for a virtual experience.

In order to accomplish the above objects, an apparatus for reconstructing an experience item in 3D according to the present invention includes a 3D data generation unit for generating 3D data by reconstructing a 3D shape of a target object to be reconstructed in 3D, a 2D data generation unit for generating 2D data by performing 2D parameterization on the 3D data, an attribute setting unit for assigning attribute information corresponding to the target object to the 3D data, an editing unit for receiving editing of the 2D data from a user, and an experience item generation unit for generating an experience item corresponding to the target object using the 3D data corresponding to the edited 2D data and the attribute information.

Here, the 2D data generation unit may generate the 2D data by performing parameterization based on projection.

Here, the 2D data generation unit may generate one or more pieces of 2D data corresponding to one or more preset directions of projection,

Here, the 2D data generation unit may parameterize the 3D data into a set of 2D meshes.

Here, the attribute setting unit may analyze a topology of the 3D data and a topology of existing data in which the attribute information is predefined, search for 3D homologous points using the topology of the 3D data and the topology of the existing data, and transfer attribute information of the existing data to the 3D data when 3D homologous points are found.

Here, the attribute setting unit may calculate connection information between each vertex of the 3D data and each vertex of the existing data, and may analyze the topology by analyzing a semantic part of the 3D data and the existing data.

Here, the 3D data generation unit may receive image information about the target object, convert the image information into 3D coordinates using a sensor parameter, and generate the 3D data using the 3D coordinates.

Here, the 3D data generation unit may generate the 3D data by applying a mesh reconstruction method or a voxel-based reconstruction method to the 3D coordinates.

Here, the 2D data generation unit may map a point of the 3D data to a point having a widest area in the 2D data in order to make a one-to-one correspondence between points of the 3D data and points of the 2D data.

Here, the editing unit may receive editing of an object that is included in the reconstructed 3D data but is not the target object or editing of an attribute that is added for a virtual experience using the experience item.

Also, a method for reconstructing an experience item in 3D, performed by an apparatus for reconstructing an experience item in 3D, according to an embodiment of the present invention includes generating 3D data by reconstructing a 3D shape of a target object to be reconstructed in 3D, generating 2D data by performing 2D parameterization on the 3D data, assigning attribute information corresponding to the target object to the 3D data, receiving editing of the 2D data from a user, and generating an experience item corresponding to the target object using the 3D data corresponding to the edited 2D data and the attribute information.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating a method for representing 3D data in a 2D plane using conventional mesh parameterization;

FIG. 2 is a view illustrating a system for reconstructing an experience item in 3D according to an embodiment of the present invention;

FIG. 3 is a view illustrating an apparatus for reconstructing an experience item in 3D according to an embodiment of the present invention;

FIG. 4 is a flowchart of a method for reconstructing an experience item in 3D according to an embodiment of the present invention;

FIG. 5 is a view illustrating an example in which 2D parameterization is performed according to an embodiment of the present invention;

FIG. 6 is a view illustrating the process of reconstructing an experience item in 3D according to an embodiment of the present invention;

FIG. 7 is a view illustrating the relationship between existing data and 3D data according to an embodiment of the present invention;

FIG. 8 is a view illustrating the process of editing a mesh in a 2D plane according to an embodiment of the present invention; and

FIG. 9 is a view illustrating an automated multi-layer modeling process according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will he described in detail with reference to the accompanying drawings.

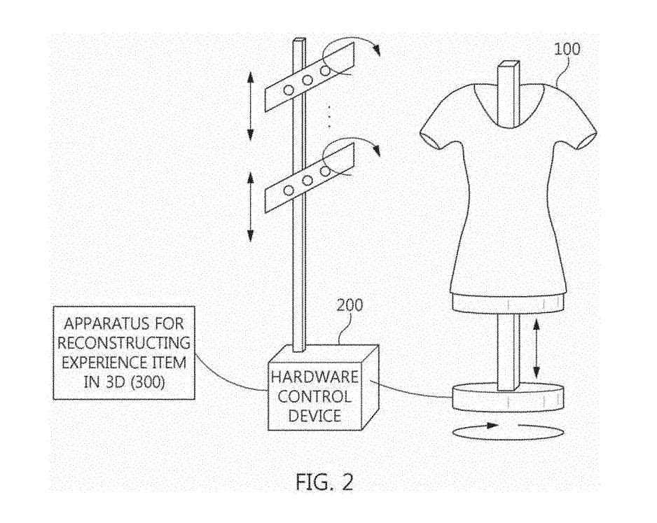

FIG. 2 is a view illustrating a system for reconstructing an experience item in 3D according to an embodiment of the present invention.

As illustrated in FIG. 2, a system for reconstructing an experience item in 3D includes a target object 100 to be reconstructed in 3D, a hardware control device 200, and an apparatus 300 for reconstructing an experience item in 3D.

First, the target object 100 is an item to be reconstructed for a virtual experience. Here, the target object 100 may be any one of an upper garment such as a jumper, a jacket, a coat, knitwear, a shirt, a T-shirt, and the like, bottoms such as a skirt, pants, and. the like, a dress such as a one-piece dress, a two-piece suit and the like, an all-in-one garment such as a ski suit and the like, and accessories such as a hat, a necktie, a muffler, a bag, shoes, and the like.

The target object 100 may be arranged on a stand such as a mannequin, and the stand may be rotatable, or the height thereof may be adjusted. Here, the mannequin may be an upper-body mannequin, a lower-body mannequin, a full-body mannequin, a mannequin head, a mannequin hand, or a mannequin foot. Also, the mannequin may be a commonly used fixed-type mannequin, or an adjustable mannequin, the size of the main body parts of which can be adjusted using a program. If the stand is an adjustable mannequin, the physical dimensions thereof, such as the head circumference, the neck circumference, the bust circumference, the belly circumference, the arm circumference, the wrist circumference, the thigh circumference, the calf circumference, the ankle circumference and the like, are adjustable.

Next, the hardware control device 200 controls an image sensor, which collects image information by capturing the image of the target object 100 to be reconstructed in 3D. The hardware control device 200 may control the position, the direction, and the like of the image sensor or the rotation of a stand on which the target object 100 is arranged, and may send the image information corresponding to the captured target object 100 to the apparatus 300 for reconstructing an experience item in 3D.

According to the conventional art, images may be captured using multiple image sensors, or images may be captured by controlling the position and direction of one or more image sensors. Alternatively, images may be captured while rotating the target object 100 to be reconstructed in 3D.

Here, a method in which images captured using multiple image sensors are used. is advantageous in that image information may be acquired in a short time, but it is costly and takes a lot of space. Also, it is necessary to correct images due to differences between the multiple image sensors.

A method in which images are captured by controlling one or more image sensors is inexpensive because a small number of sensors are used, and more data may be acquired using the continuously moving sensors. However, it takes a lot of time to acquire image information due to the physical movement of the sensors, and it requires a large space.

A method in which images are captured while the target object 100 is rotated is advantageous in that it takes less space and that it is inexpensive. However, the range that can be captured by an image sensor is limited, and if light having directionality is used, the light may have a different effect on the target object 100 according to the rotation of the target object 100, thus requiring post processing.

Therefore, in order to take the advantages of the conventional arts, the hardware control device 200 according to an embodiment of the present invention rotates the target object 100 and controls one or more image sensors so as to move up and down, whereby the image of the target object 100 may be captured while it is rotated, as shown in FIG. 2. Also, the hardware control device 200 may extend the range that can be captured by the one or more image sensors by controlling the image sensors so as to tilt.

Finally, the apparatus 300 for reconstructing an experience item in 3D creates an experience item corresponding to the target object 100 using the image information.

The apparatus 300 reconstructs the 3D shape of the target object 100 and parameterizes the reconstructed 3D data into a set of 2D meshes for a user who is accustomed to a 2D authoring environment. Also, the apparatus 300 assigns attributes necessary for a virtual experience to the reconstructed 3D data.

Also, the apparatus 300 receives edits from a user in a 2D authoring environment and creates an experience item corresponding to the target object 100 by reflecting the received edits.

For the convenience of description, the hardware control device 200 is described. as being separate from the apparatus 300 for reconstructing an experience item in 3D, but without limitation thereto, the apparatus 300 may also perform the functions of the hardware control device 200.

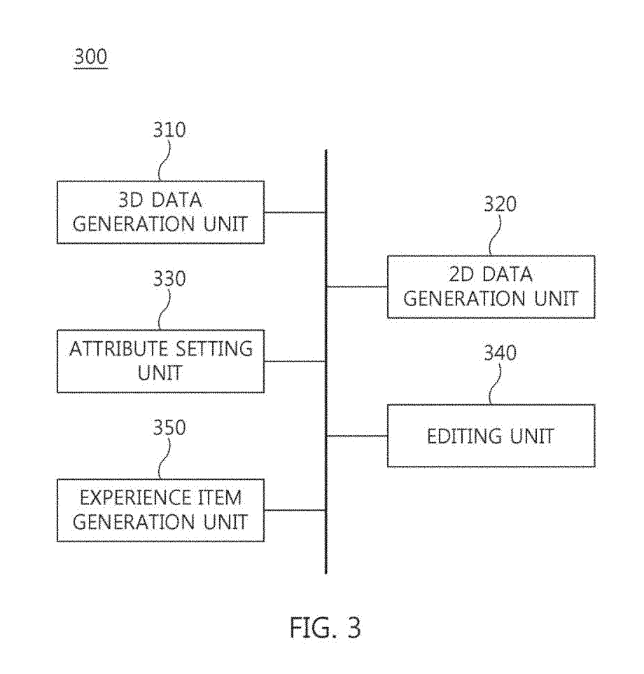

FIG. 3 is a view illustrating an apparatus for reconstructing an experience item in 3D according to an embodiment of the present invention.

As illustrated in FIG. 3, the apparatus 300 for reconstructing an experience item in 3D includes a 3D data generation unit 310, a 2D data generation unit 320, an attribute setting unit 330, an editing unit 340, and an experience item generation unit 350.

First, the 3D data generation unit 310 generates 3D data by reconstructing the 3D shape of a target object 100 to be reconstructed in 3D.

Here, the 3D data generation unit 310 generates 3D data by receiving image information about the target object 100, converting the image information into 3D coordinates using a sensor parameter, and applying a mesh reconstruction technique or a voxel-based reconstruction technique to the 3D coordinates.

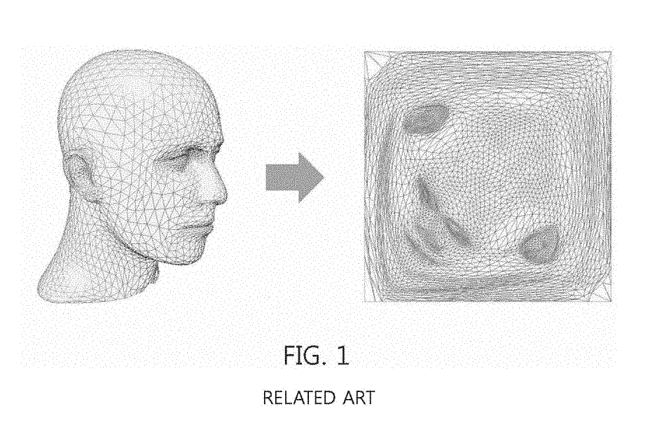

Next, the 2D data generation unit 320 generates 2D data by parametrizing the generated 3D data into 2D data. Here, 2D parameterization means technology for representing 3D data in a 2D plane, as shown in FIG. 1.

The 2D data generation unit 320 may generate 2D data by performing parameterization based on projection. Here, one or more pieces of 2D data corresponding to one or more projection directions may be generated. Also, the 2D data generation unit 320 may parameterize the 3D data into a set of 2D meshes.

Also, in order to prevent a point of the 3D data from being mapped to multiple points in a 2D plane, the 2D data generation unit 320 may map each point of the 3D data to the point having the widest area in the 2D data, so that one-to-one correspondence between points of the 3D data and points of the 2D data may be made.

Next, the attribute setting unit 330 assigns attribute information corresponding to the target object 100 to the 3D data.

Also, the attribute setting unit 330 analyzes the topology of the 3D data and the topology of existing data in which attribute information is predefined. Then, the attribute setting unit 330 searches for homologous 3D points using the topology of the 3D data and the topology of the existing data. When homologous 3D points are found, the attribute setting unit 330 transfers the attribute information of the existing data to the 3D data.

Here, the attribute setting unit 330 may analyze the topology by calculating information about the connections between the vertices in the 3D data and existing data and by analyzing semantic parts of the 3D data and the existing data.

The editing unit 340 receives editing of 2D data from a user. Here, the editing of 2D data may be editing to remove an object that is not a target object to be reconstructed from the reconstructed 3D data or editing of an attribute to be added for a virtual experience using the experience item.

Finally, the experience item generation unit 350 generates an experience item corresponding to the target object 100 using the 3D data corresponding to the edited 2D data and the attribute information.

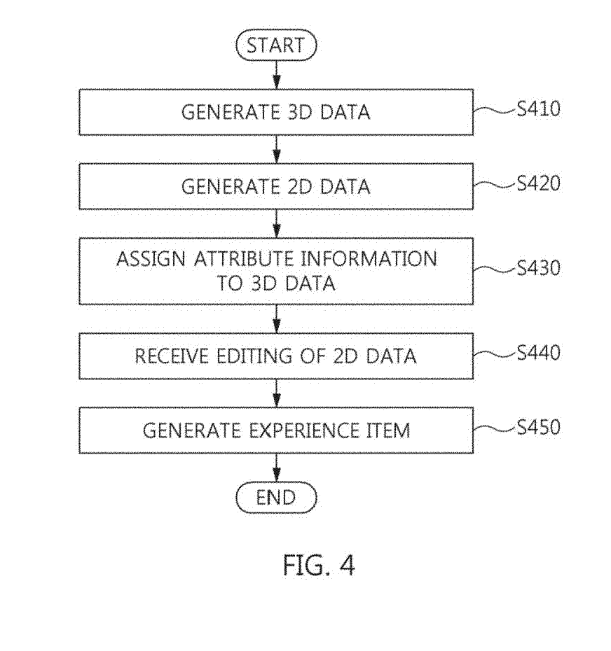

Hereinafter, a method for reconstructing an experience item in 3D according to an embodiment of the present invention will be described in detail with reference to FIGS. 4 to 8.

FIG. 4 is a flowchart illustrating the method for reconstructing an experience item in 3D according to an embodiment of the present invention.

First, an apparatus 300 for reconstructing an experience item in 3D generates 3D data at step S410 by reconstructing the 3D shape of the target object 100 to be reconstructed in 3D.

Here, the apparatus 300 converts image information about the target object 100 into 3D coordinates using a sensor parameter. Then, the apparatus 300 generates 3D data, that is, 3D geometry, using the 3D coordinates.

Specifically describing the process of generating 3D data, the apparatus 300 receives one or more pieces of image information about the target object 100 from an image sensor or an external hardware control device. Then, the received image information is converted into 3D coordinates by correcting it using a sensor parameter.

When the 3D shape is reconstructed using the image information, the apparatus 300 may increase the precision thereof by using color image information captured by one or more image sensors or by adding depth image information. Most scanners based. on active techniques for acquiring depth image information project a pattern or a laser onto the surface of an object and capture the image of the object onto which the pattern or the laser is projected, and then the 3D coordinates of the target object 100 are acquired through a triangulation method. Also, for more precise reconstruction, the apparatus 300 may reconstruct the 3D shape using color and depth image information corresponding to various angles, as illustrated in FIG. 2.

Also, the apparatus 300 converts the acquired color image information and depth information into 3D coordinates using a sensor parameter. Here the sensor parameter may include external parameters such as the position and direction of the image sensor and internal parameters such as information about the lens of the image sensor or the like.

When generating 3D data using the converted 3D coordinates, the apparatus 300 may apply a mesh reconstruction method or a voxel-based reconstruction method, which may increase the speed of reconstruction and interpolate 3D coordinates. Here, the voxel-based reconstruction method may apply a Marching Cube method, a method using a distance field, and the like.

Specifically, the voxel-based reconstruction method defines a 3D space that contains the target object 100 and partitions the defined space into sections having a uniform size (voxels), whereby the 3D space may be represented. Then, the distance from each of the voxels, which are present in a certain area based on the acquired 3D coordinates, to the 3D position of the image sensor, by which the 3D coordinates have been acquired, is computed and added to the each of the voxels.

Also, in order to generate a distance field, if the distance from a voxel to the origin of the image sensor is less than the distance determined using the acquired 3D coordinates relative to the origin of the image sensor, the apparatus 300 cumulatively adds a positive value, and if not, the apparatus 300 cumulatively adds a negative value. Then, 3D data, that is, the integrated 3D geometry, is generated from the collected information about the voxels using a Marching Cube method or the like.

Then, the apparatus 300 generates 2D data by parametrizing the generated 3D data into 2D data. Here, 2D parameterization means technology for representing 3D data in a 2D plane, as shown in FIG. 1.

The apparatus 300 generates 2D data by parameterizing the 3D data into 2D data in order for a user to easily edit the 3D data, and receives the result of editing of the generated 2D data from the user. Also, the apparatus 300 may convert the 2D data edited by the user into 3D data again to thus perform the interconversion between 3D data and 2D data.

The apparatus 300 may perform parameterization to convert data into any type that can be easily edited by a user. Particularly, 2D data may be generated by performing parameterization based on projection. Also, the apparatus 300 may generate one or more pieces of 2D data corresponding to one or more preset directions of projection.

In order to perform parameterization based on projection, the 2D data generation unit 320 analyzes one or more directions of projection, the view plane of which includes the 3D data. Here, if the 3D data is not included in the view plane of projection, a user may set another direction of projection.

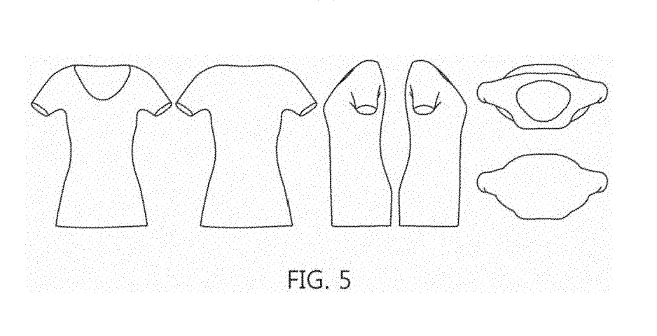

FIG. 5 is a view illustrating an example in which 2D parameterization is performed according to an embodiment of the present invention.

As illustrated in FIG. 5, the apparatus 300 for reconstructing an experience item in 3D may perform parameterization as if a target object 100 to be reconstructed in 3D were viewed from the front, the back, the left, the right, above, and below. Here, 2D parameterization enables a user to more easily edit the target object 100 than when the user edits the 3D data of the target object 100 in a 3D space.

Here, in order to enable the interconversion between 2D data and 3D data, it is necessary to make one-to-one correspondence between points of the 3D data and points of the 2D data. Accordingly, a single point in the 3D space is prevented from being mapped to multiple points in a 2D plane. To this end, the apparatus 300 maps a point of the 3D data to the widest area, selected from among the areas of the 2D plane that correspond to the point of the 3D data. Also, for the convenience of a user, the apparatus 300 may show the user the result of the one-to-one correspondence between points of the 3D data and points of the 2D data, or the result of the one-to-N correspondence therebetween.

Meanwhile, when 2D parameterization is performed, there may be a part that cannot be mapped to any point in a 2D plane due to the shape of the target object 100. In this case, 2D data may be generated using another parameterization method according to the conventional art.

Subsequently, the apparatus 300 for reconstructing an experience item in 3D assigns attribute information to the 3D data at step S430.

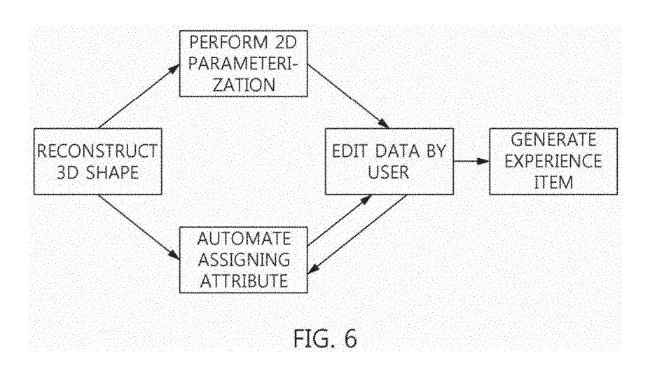

FIG. 6 is a view illustrating the process of reconstructing an experience item in 3D according to an embodiment of the present invention.

As illustrated in FIG. 6, after performing step S410, in which 3D data are generated by reconstructing a 3D shape, the apparatus 300 for reconstructing an experience item in 3D may separately perform step S420 for generating 2D data through 2D parameterization and step S430 for automatically assigning attributes. Here, for the convenience of description, step 5420 is described as being performed before step S430, but the order is not limited to this.

At step S430, the apparatus 300 analyzes the 3D data in order for a system to automatically calculate the attributes, and may assign the attribute information to the 3D data.

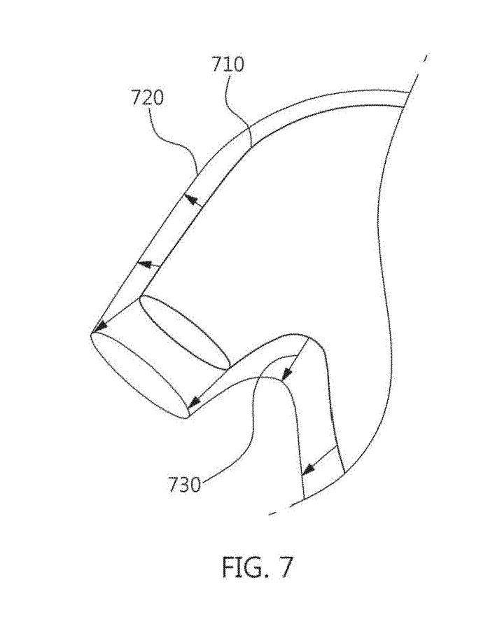

FIG. 7 is a view illustrating the relationship between existing data and 3D data according to an embodiment of the present invention.

As illustrated in FIG. 7, in order to automatically assign attributes, the apparatus 300 for reconstructing an experience item in 3D analyzes the topology 710 of existing data and the topology 720 of the 3D data, which correspond to the target object 100 to be reconstructed in 3D. The apparatus 300 analyzes the topology of the existing data and the topology of the 3D data and searches for homologous 3D points and the relationship 730 therebetween using the analyzed topology of the 3D data and existing data.

Here, the topology 720 of the 3D data may be the same as or different from the topology 710 of the existing data. As shown in FIG. 7, if the target object 100 to be reconstructed in 3D is clothing, the apparatus 300 calculates attributes using clothing that has the same shape but has a different size, or the attributes of a skirt may be calculated based on pants, which have topology different from that of the skirt. Also, the apparatus 300 may calculate the attributes of the target object 100 based on a precisely defined human avatar.

When homologous points are found, the apparatus 300 transfers the attributes of the existing data to the 3D data. The transfer of attribute data may be performed by copying values, or may be performed using the distance between points, a normal line, and the like. Here, the apparatus 300 may transfer the attribute data using attribute values of multiple points, which are mapped to a point in the 3D data.

Here, the attributes may be calculated using a different method depending on the type thereof. If the attribute is elasticity for a physical simulation, the attribute may be calculated using the distance between two vertices. The calculated attribute may be directly assigned without editing by a user, or may be used as an initial value when a user assigns the attribute.

Also, the apparatus 300 receives editing of the 2D data from a user at step S440.

When the 3D shape of a target object 100 is reconstructed using image information, another part, other than the target object 100, may also be reconstructed. For example, when the target object 100 is clothing, a mannequin on which the clothing is arranged may also be reconstructed when the 3D shape of the clothing is reconstructed.

Also, for a virtual experience, it is necessary to assign additional attributes to the experience item corresponding to the target object 100, besides the geometry thereof. For example, in the case of a virtual clothing fitting system, the clothing corresponding to the experience item may be made responsive to the motion of a user. To this end, skinning is performed so as to attach the clothing to the skeleton, and a weight is assigned to each bone according to the motion of the user.

For example, when animation based on a skeleton is performed, the apparatus 300 associates each vertex of the target object 100 with one or more bones that affect the vertex, and sets a weighting of influence.

In the conventional art, because a user manually associates each vertex with bones in a 3D authoring environment, it takes a lot of time. Furthermore, because a weighting is automatically set only using the relationship between the vertex and bones, the quality is low.

However, the apparatus 300 for reconstructing an experience item in 3D automates the process of associating a vertex with bones and setting a weighting. The apparatus 300 uses existing data, such as an item or a human body avatar, to which attributes have been assigned in advance, together with the reconstructed 3D data and searches for homologous points between the existing data and the 3D data. Here, the existing data may have one or more points mapped to each point of the 3D data, but may alternatively have no point mapped thereto.

If the existing data have one or more mapped points, skinning information for the point in the 3D data may be calculated using skinning information about the mapped points of the existing data, wherein the skinning information may include bones that affect a point, a weighting, and the like. Conversely, if there is no mapped point in the existing data, skinning information for the point in the 3D data may be calculated using neighboring points that have mapped points in the existing data.

Also, the apparatus 300 may apply a physical simulation to an experience item in order to improve the level of realism of a virtual experience. In this case, physical attributes, such as a weight, elasticity, a maximum moving distance, and the like, may be assigned to each vertex.

As described above, in order to convert the reconstructed 3D data into an experience item, objects other than a target object are removed through editing, additional attributes are assigned to an experience item, or a physical simulation is applied to the experience item. To this end, the apparatus 300 may receive editing of 2D data at step S440.

Here, in order to enable users who are not accustomed to a 3D editing and authoring environment to easily edit the 3D data, the apparatus 300 provides 2D data, generated through 2D parameterization, in a 2D plane. Also, in order to improve the quality of the process of automatically assigning attributes, the apparatus 300 may provide guidelines. Here, in order to handle various situations during the editing, guidelines about a detailed method for editing 3D geometry, assigning attributes, and the like may be provided.

At step S440 for receiving editing of the 2D data, the process of receiving editing from a user and the process of automatically assigning attributes may be repeatedly performed as shown in FIG. 6, whereby a digital experience item that has a form suitable for experiencing the virtual item may be created.

For example, when a user selects a mesh in a 2D plane or inputs a command for deleting a selected mesh, the apparatus 300 inversely converts the 2D plane into a 3D space and edits the 3D data corresponding to the selected mesh or the deleted mesh,

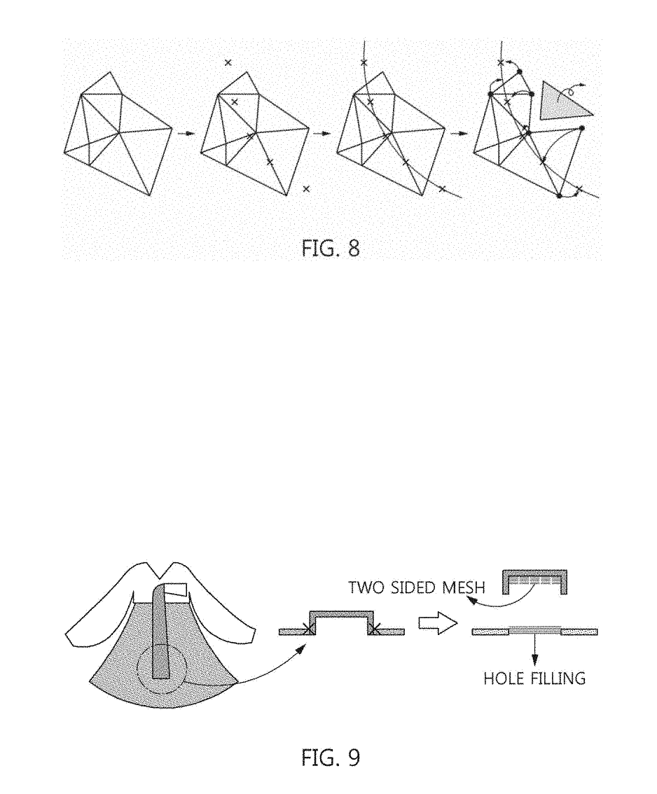

FIG. 8 is a view illustrating the process of editing a mesh in a 2D plane according to an embodiment of the present invention.

As illustrated in FIG. 8, when a user presents a curve in a 2D plane, the apparatus 300 for reconstructing an experience item in 3D partitions the plane based on meshes. Here, the apparatus 300 edits existing vertices of a mesh so as to be moved onto the curve, or may cut off the triangular mesh based on the curve rather than moving the vertices thereof, as shown in FIG. 8. Then, the 3D data, from which unnecessary parts are removed, may be used to visualize the shape of an experience item at step S450, which will be described later.

Finally, the apparatus 300 for reconstructing an experience item in 3D generates an experience item at step S450.

The apparatus 300 analyzes 3D geometry and reflects attributes acquired by analyzing the 3D data or physical attributes input by a user. For example, when a simulation based on a spring is applied, the length of the spring in its equilibrium state, elasticity, and the like may be set using the distance between vertices. Also, if the spring is arranged to oscillate in the vertical direction, the spring may be processed differently from other springs in order to take into account the effect of gravity. In the process of reflecting physical attributes, not only the attributes acquired by analyzing the 3D geometry of the target object 100, such as an equilibrium state, elasticity, a length, and the like, but also physical attributes input by a user, such as a maximum moving distance, mass, and the like, may be reflected.

Also, the apparatus 300 may impose physical constraints based on the 3D geometry and physical attributes in order to maintain a natural shape when a physical simulation is performed. Here, the apparatus 300 may maintain a reconstructed shape by setting the minimum and maximum distance between vertices, or may impose a constraint on penetration in order to prevent the reconstructed item from being penetrated by another object when it is in contact with the other object. Then, the apparatus 300 creates an experience item that includes 3D data, physical attributes, and physical constraints.

FIG. 9 is a view illustrating an automated multi-layer modeling process according to an embodiment of the present invention.

In order to increase the level of realism in an experience service that includes a physical simulation, the apparatus 300 for reconstructing an experience item in 3D may perform multi-layer modeling. For example, when the experience item illustrated in FIG. 9 is generated, the 3D data, reconstructed using image information, may have an all-in-one type, that is, the layer of a skirt does not separate from the layer of a coat string.

In this case, the apparatus 300 may receive a part on which multi-layer modeling is to be performed from a user in the step of receiving editing from a user. Then, in the step of automatically assigning attributes, the apparatus 300 cuts off a 3D mesh based on the input part, on which multi-layer modeling is to be performed, and fills the part, from which the mesh is removed (i.e. the part of the skirt) using a hole-filling method. Also, the detached part (the part of the coat string) may be made a two-sided mesh.

Meanwhile, the apparatus 300 for reconstructing an experience item in 3D may reconstruct an experience item regardless of the kind of mannequin that is used. In the conventional art, in which a human body avatar is used, because the 3D geometry of the virtual avatar must be the same as that of the mannequin, the mannequin is produced using a computerized numerical control machine, a 3D printer, or the like in order to faithfully copy the shape of the virtual avatar. Alternatively, in the conventional method, a mannequin is reconstructed in a 3D digital format so as to make an avatar and necessary attributes such as skinning information are manually assigned to the avatar.

In the case of the conventional method in which a mannequin is produced. to copy the shape of a virtual avatar, expense for producing the mannequin is incurred, and the shape and type of the mannequin may be limited. Also, in the method for reconstructing a mannequin in a 3D digital format, it takes a lot of time and expense because the virtual avatar is created manually. Furthermore, most mannequins having joints deform when items are arranged thereon, but such deformation may not be reflected in the avatar.

However, the apparatus 300 for reconstructing an experience item in 3D reconstructs only a mannequin and then generates a virtual avatar from the reconstructed mannequin using an existing virtual avatar. The generated virtual avatar is used for an item that is reconstructed by being worn on the mannequin, which corresponds to the generated virtual avatar. The apparatus 300 overlays the virtual avatar, generated using the same mannequin, with the item, which is converted into 2D data.

Here, when 3D data are generated by reconstructing the 3D shape of an item, if a mannequin is deformed, the apparatus 300 receives the corresponding point of the mannequin, which is reconstructed along with the virtual avatar and item, from a user. If there is no corresponding point in the mannequin, a point, predicted from the shape of the item, may be input.

Also, the apparatus 300 calculates information about the deformation of the mannequin using inverse kinematics based on the input point. Here, inverse kinematics is concept that is the opposite of kinematics. That is, kinematics pertains to calculation of the final positions of vertices using information about joints, such as the length, the direction, and the like thereof. Conversely, inverse kinematics means the process of calculating information about joints, which determine the final positions of vertices. Also, the apparatus 300 deforms the virtual avatar using the calculated information about the deformation and generates a temporary avatar customized to the item. Here, the generated avatar customized to the item may be used as a reference avatar in the following processes,

According to the present invention, a 3D shape may be quickly reconstructed at low cost through an automated technique for reconstructing a 3D item using image information.

Also, the present invention enables a user, unaccustomed to a 3D authoring environment, to easily edit 3D data in a 2D authoring environment.

Also, the present invention may easily supply experience items by enabling the quick and simple creation of digital experience items for a virtual experience.

As described above, the apparatus and method for reconstructing an experience item in 3D according to the present invention are not limitedly applied to the configurations and operations of the above-described embodiments, but all or some of the embodiments may be selectively combined and configured so that the embodiments may be modified in various ways.

What is claimed is:

1. An apparatus for reconstructing an experience item in 3D, comprising:
a 3D data generation unit for generating 3D data by reconstructing a 3D shape of a target object to be reconstructed in 3D;
a 2D data generation unit for generating 2D data by performing 2D parameterization on the 3D data;
an attribute setting unit for assigning attribute information corresponding to the target object to the 3D data;
an editing unit for receiving editing of the 2D data from a user; and
an experience item generation unit for generating an experience item corresponding to the target object using the 3D data corresponding to the edited 2D data and the attribute information.

2. The apparatus of claim 1, wherein the 2D data generation unit generates the 2D data by performing parameterization based on projection.

3. The apparatus of claim 2, wherein the 2D data generation unit generates one or more pieces of 2D data corresponding to one or more preset directions of projection.

4. The apparatus of claim 1, wherein the 2D data generation unit parameterizes the 3D data into a set of 2D meshes.

5. The apparatus of claim 1, wherein the attribute setting unit is configured to:
analyze a topology of the 3D data and a topology of existing data in which the attribute information is predefined;
search for 3D homologous points using the topology of the 3D data and the topology of the existing data; and
transfer attribute information of the existing data to the 3D data when 3D homologous points are found.

6. The apparatus of claim 5, wherein the attribute setting unit is configured to:
calculate connection information between each vertex of the 3D data and each vertex of the existing data; and
analyze the topology by analyzing a semantic part of the 3D data and the existing data.

7. The apparatus of claim 1, wherein the 3D data generation unit is configured to:
receive image information about the target object;
convert the image information into 3D coordinates using a sensor parameter; and
generate the 3D data using the 3D coordinates.

8. The apparatus of claim 7, wherein the 3D data generation unit generates the 3D data by applying a mesh reconstruction method or a voxel-based reconstruction method to the 3D coordinates.

9. The apparatus of claim 1, wherein the 2D data generation unit maps a point of the 3D data to a point having a widest area in the 2D data in order to make a one-to-one correspondence between points of the 3D data and points of the 2D data.

10. The apparatus of claim 1, wherein the editing unit receives editing of an object that is included in the reconstructed 3D data but is not the target object or editing of an attribute that is added for a virtual experience using the experience item.

11. A method for reconstructing an experience item in 3D, performed by an apparatus for reconstructing an experience item in 3D, comprising:
generating 3D data by reconstructing a 3D shape of a target object to be reconstructed in 3D;
generating 2D data by performing 2D parameterization on the 3D data;
assigning attribute information corresponding to the target object to the 3D data;
receiving editing of the 2D data from a user; and
generating an experience item corresponding to the target object using the 3D data corresponding to the edited 2D data and the attribute information.

12. The method of claim 11, wherein the generating the 2D data is configured to generate the 2D data by performing parameterization based on projection.

13. The method of claim 12, wherein the generating the 2D data is configured to generate one or more pieces of 2D data corresponding to one or more preset directions of projection.

14. The method of claim 11, wherein the generating the 2D data is configured to parameterize the 3D data into a set of 2D meshes.

15. The method of claim 11, wherein the assigning the attribute information comprises:
analyzing a topology of the 3D data and a topology of existing data in which the attribute information is predefined;
searching for 3D homologous points using the topology of the 3D data and the topology of the existing data; and
transferring attribute information of the existing data to the 3D data when 3D homologous points are found.

16. The method of claim 15, wherein the analyzing is configured to:
calculate connection information between each vertex of the 3D data and each vertex of the existing data; and
analyze the topology by analyzing a semantic part of the 3D data and the existing data.

17. The method of claim 11, wherein the generating the 3D data comprises:
receiving image information about the target object;
converting the image information into 3D coordinates using a sensor parameter; and
generating the 3D data using the 3D coordinates.

18. The method of claim 17, wherein the generating the 3D data is configured to generate the 3D data by applying a mesh reconstruction method or a voxel-based reconstruction method to the 3D coordinates.

19. The method of claim 11, wherein the generating the 2D data is configured to map a point of the 3D data to a point having a widest area in the 2D data in order to make a one-to-one correspondence between points of the 3D data and points of the 2D data.

20. The method of claim 11, wherein the receiving the editing is configured to receive editing of an object that is included in the reconstructed 3D data but is not the target object or editing of an attribute that is added for a virtual experience using the experience item.
